(19) United States
(12) Patent Application Publication
(10) Pub. No.: US 2022/0189222 A1
(43) Pub. Date: Jun. 16, 2022

(54) AUTHENTICATION SYSTEM, MOBILE DEVICE, PROCESSING DEVICE, AND NON-TRANSITORY COMPUTER-READABLE MEDIUM

(71) Applicant: KABUSHIKI KAISHA TOKAI RIKA DENKI SEISAKUSHO, Aichi (JP)

(72) Inventor: Masanori KOSUGI, Aichi (JP)

(73) Assignee: KABUSHIKI KAISHA TOKAI RIKA DENKI SEISAKUSHO, Aichi (JP)

(21) Appl. No.: 17/502,644

(22) Filed: Oct. 15, 2021

(30) Foreign Application Priority Data
Dec. 11, 2020 (JP) 2020-205874

(51) Int. Cl. G07C 9/00

(52) U.S. Cl. CPC G07C 9/0073; G07C 2009/00357; G07C 9/00309

(57) ABSTRACT

A communication device is configured to form a wireless communication area at least outside of a cabin arranged to be opened/closed by an opening/closing body. A magnetic source is configured to form a magnetic field at least outside of the cabin. A mobile device is adapted to be carried by a user. A magnetic sensor is installed in the mobile device and configured to detect magnetism. A control device is configured to determine whether an authentication processing for authenticating the mobile device located in the wireless communication area with radio waves is succeeded, and configured to control an operation of a controlled device in a case where a specific magnetism is detected by the magnetic sensor and it is determined that the authentication processing is succeeded.

### FIELD

The presently disclosed subject matter relates to an authentication system using a mobile device capable of being carried by a user. The presently disclosed subject matter also relates to a control device that may be included in the authentication system. The presently disclosed subject matter also relates to a mobile device that may be included in the authentication system. The presently disclosed subject matter also relates to a non-transitory computer-readable medium having recorded a computer program executable by a processor installed in the control device. The presently disclosed subject matter also relates to a non-transitory computer-readable medium having recorded a computer program executable by a processor installed in the mobile device.

### BACKGROUND

Japanese Patent Publication No. 2016-211334A discloses an authentication system adapted to be installed in a vehicle. In the system, authentication is performed between a control device for controlling the operation of a locking/unlocking device of a vehicle door and a mobile device carried by a user through communication with radio waves. When the authentication is approved in a state where the user touches a touch sensor provided in a door knob, the control of the operation of the locking/unlocking device by the control device is permitted.

### SUMMARY

### Technical Problem

It is demanded to enhance the convenience of the authentication system using the mobile device.

### Solution to Problem

In order to meet the demand described above, an illustrative aspect of the presently disclosed subject matter provides an authentication system, comprising:

a communication device configured to form a wireless communication area at least outside of a cabin arranged to be opened/closed by an opening/closing body;

a magnetic source configured to form a magnetic field at least outside of the cabin;

a mobile device adapted to be carried by a user;

a magnetic sensor installed in the mobile device and configured to detect magnetism; and

a control device configured to determine whether an authentication processing for authenticating the mobile device located in the wireless communication area with radio waves is succeeded, and configured to control an operation of a controlled device in a case where a specific magnetism is detected by the magnetic sensor and it is determined that the authentication processing is succeeded.

In order to meet the demand described above, an illustrative aspect of the presently disclosed subject matter provides a control device configured to control an operation of a controlled device, comprising:

a processor configured to cause a communication device to form a wireless communication area at least outside of a cabin arranged to be opened/closed by an opening/closing body, and configured to determine whether an authentication processing for authenticating a mobile device adapted to be carried by a user located in the wireless communication area with radio waves is succeeded; and

a reception interface configured to receive, from the mobile device with the radio waves, a magnetism detection signal indicating that the mobile device detects a specific magnetism,

wherein the processor is configured to control the operation of the controlled device in a case where the reception interface receives the magnetism detection signal and it is determined that the authentication processing is succeeded.

In order to meet the demand described above, an illustrative aspect of the presently disclosed subject matter provides a mobile device adapted to be carried by a user, comprising:

a transmitter configured to transmit an authentication signal including information required by an authentication processing for authenticating the mobile device to a communication device configured to form a wireless communication area at least outside of a cabin arranged to be opened/closed by an opening/closing body;

a magnetic sensor installed in the mobile device and configured to detect magnetism of a magnetic field formed at least outside of the cabin;

a processor configured to transmit a magnetism detection signal from the transmitter to the communication device in a case where the magnetic sensor detects a specific magnetism.

In order to meet the demand described above, an illustrative aspect of the presently disclosed subject matter provides a non-transitory computer-readable medium having recorded a computer program adapted to be executed by a processor installed in a control device configured to control an operation of a controlled device, and configured to, when executed, cause the control device to:

cause a communication device to form a wireless communication area at least outside of a cabin arranged to be opened/closed by an opening/closing body;

determine whether an authentication processing for authenticating a mobile device adapted to be carried by a user located in the wireless communication area with radio waves is succeeded;

determine whether a magnetism detection signal indicating that the mobile device detects a specific magnetism is received from the mobile device with the radio waves; and

control the operation of the controlled device in a case where the reception interface receives the magnetism detection signal and it is determined that the authentication processing is succeeded.

In order to meet the demand described above, an illustrative aspect of the presently disclosed subject matter provides a non-transitory computer-readable medium having recorded a computer program adapted to be executed by a processor installed in a mobile device adapted to be carried by a user, and configured to, when executed, cause the mobile device to:

transmit an authentication signal including information required by an authentication processing for authenticating the mobile device to a communication device configured to form a wireless communication area at least outside of a cabin arranged to be opened/closed by an opening/closing body;

cause a magnetic sensor to detect magnetism formed at least outside of the cabin;

determine whether a specific magnetism is detected by the magnetic sensor; and

transmit a magnetism detection signal to the communication device in a case where it is determined that the specific magnetism is detected.

With the configuration according to each of the illustrative aspects described above, when the mobile device carried by the user enters the wireless communication area formed at least outside the cabin, the authentication processing is initiated, and when the magnetic source detects magnetism having an intensity that is no less than the threshold value caused by the magnetic field formed at least outside the cabin, the operation control of the controlled device is permitted. That is, the user does not need to perform an operation input with respect to the mobile device in order to cause the control device to perform the operation control of the controlled device, nor does the user need to perform a touch operation with respect to a door handle or the like. Since the user can operate the controlled device with a minimum amount of operation outside the cabin, and there is no need to provide a facility such as a touch sensor on the opening/closing body, it is possible to enhance the convenience of the authentication system using the mobile device that can be carried by the user.

Further, by setting the range in which the magnetism having such an intensity is detected to, for example, approximately several tens of centimeters (the communication distance assumed by the proximity wireless communication) from the communication device, the controlled device can be operated by an operation of holding the mobile device over the position where the communication device is disposed. That is, it is possible to provide the user with a feeling of operation like the proximity wireless communication without additionally providing a facility for realizing the proximity wireless communication.

### BRIEF DESCRIPTION OF DRAWINGS

FIG. 1 illustrates a configuration of an authentication system according to a first embodiment.

FIG. 2 illustrates a functional configuration of the authentication system according to the first embodiment.

FIG. 3 illustrates an exemplary flow of processing executed in a control device according to the first embodiment.

FIG. 4 illustrates an exemplary flow of processing executed in a mobile device according to the first embodiment.

FIG. 5 illustrates another example of a magnetic source according to the first embodiment.

FIG. 6 illustrates another exemplary flow of processing executed in the mobile device according to the first embodiment.

FIG. 7 illustrates another exemplary flow of processing executed in the control device according to the first embodiment.

FIG. 8 is a diagram for explaining an operation of a tilt sensor according to the first embodiment.

FIG. 9 illustrates another exemplary flow of processing executed in the mobile device according to the first embodiment.

FIG. 10 illustrates a functional configuration of an authentication system according to a second embodiment.

FIG. 11 illustrates an exemplary flow of processing executed in a control device according to the second embodiment.

FIG. 12 illustrates another exemplary flow of processing executed in the control device according to the second embodiment.

FIG. 13 illustrates another exemplary flow of processing executed in the control device according to the second embodiment.

### DESCRIPTION OF EMBODIMENTS

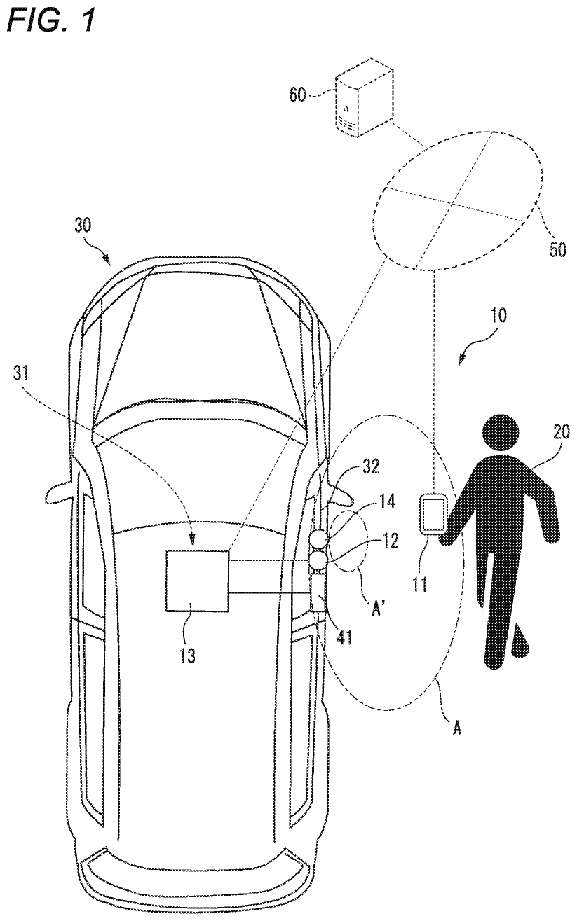

Examples of embodiments will be described in detail below with reference to the accompanying drawings. FIG. 1 illustrates a configuration of an authentication system 10 according to a first embodiment.

The authentication system 10 includes a mobile device 11. The mobile device 11 is a device capable of being carried by a user 20. The authentication system 10 may be used to authorize, for example, the use of a vehicle 30 by the user 20 carrying the mobile device 11 by authenticating the mobile device 11. The vehicle 30 is an example of the mobile entity.

The authentication system 10 includes a communication device 12. The communication device 12 includes a configuration including an antenna capable of forming a wireless communication area A at least outside the vehicle cabin 31. The wireless communication area A is an area capable of performing short-range wireless communication with the mobile device 11.

As used herein, the term “short-range wireless communication” means wireless communication performed in accordance with standard IEEE 802.15 or IEEE 802.11. Examples of the technology capable of executing such wireless communication include Bluetooth (registered trademark), Bluetooth Low Energy (registered trademark), Ultra Wide Band (UWB), ZigBee (registered trademark), and Wi-Fi (registered trademark). As used herein, the term “short-range wireless communication” is distinguished from “proximity wireless communication” using a non-contact communication technique in which information is transmitted through a coupling based on electromagnetic induction. Examples of the technique capable of executing the proximity wireless communication include an RF-ID (Radio Frequency Identification) and an NFC (Near-Field Communication).

As used herein, the expression “transmitting a signal by radio wave” means wirelessly transmitting a signal by radio waves at a frequency or a frequency band defined in the short-range wireless communication standard described above.

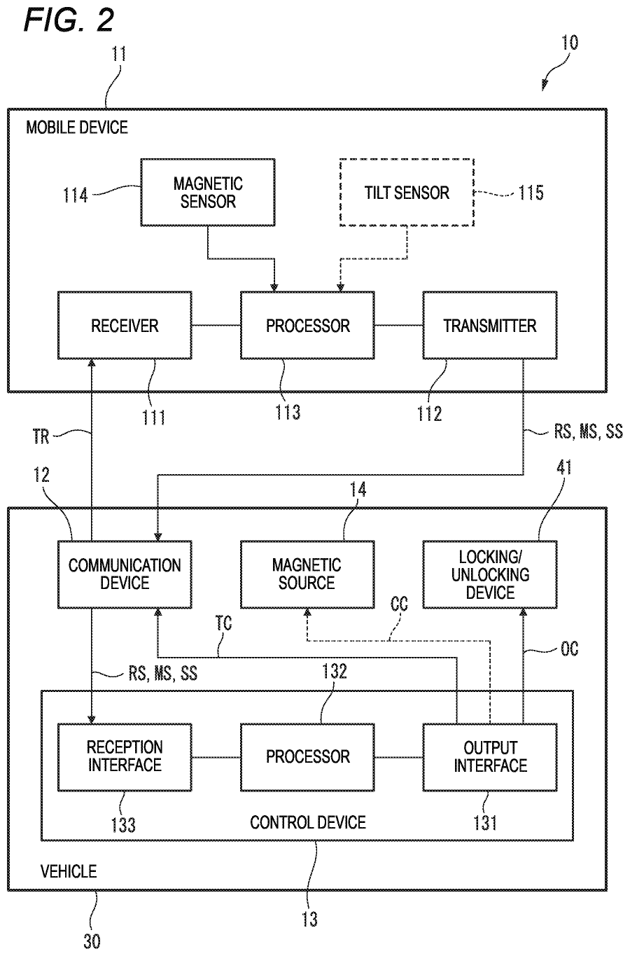

Specifically, in the communication device 12, the characteristics and arrangement of the antenna are determined so as to transmit a trigger signal TR (described later with reference to FIG. 2) by radio waves to at least the outside of a vehicle cabin 31. In this example, the communication device 12 is disposed in a door 32. The communication device 12 may be disposed on a door handle, a pillar, a door mirror, or the like.

The authentication system 10 includes a control device 13. In this example, the control device 13 is installed in the vehicle 30. The control device 13 is configured to control the operation of a locking/unlocking device 41 installed in the vehicle 30 based on the authentication processing for authenticating the mobile device 11 having received the trigger signal TR. The locking/unlocking device 41 is a device for locking/unlocking the door 32 for opening/closing the vehicle cabin 31 of the vehicle 30. The vehicle cabin 31 is an example of a cabin. The door 32 is an example of an opening/closing body. The locking/unlocking device 41 is an example of a controlled device.

As illustrated in FIG. 2, the control device 13 includes an output interface 131. The output interface 131 is configured as an interface capable of outputting various signals. The various signals may be analog signals or digital signals. When an analog signal is outputted, the output interface 131 includes an appropriate conversion circuit including a D/A converter.

The control device 13 includes a processor 132. The processor 132 is configured to output a transmission control signal TC from the output interface 131. The communication device 12 is configured to transmit the trigger signal TR by radio waves based on the transmission control signal TC. The trigger signal TR may be continuously transmitted, or may be intermittently transmitted at prescribed time intervals.

On the other hand, the mobile device 11 includes a receiver 111. The receiver 111 includes a configuration including an antenna capable of receiving the trigger signal TR transmitted from the communication device 12 through the short-range wireless communication described above.

The mobile device 11 includes a transmitter 112. The transmitter 112 includes a configuration including an antenna capable of transmitting various signals to the communication device 12 through the short-range wireless communication described above.

The mobile device 11 includes a processor 113. When the trigger signal TR is received by the receiver 111, the processor 113 is configured to transmit a response signal RS from the transmitter 112 to the communication device 12 by radio waves.

The response signal RS is configured to include authentication information that is required for the authentication of the mobile device 11. The authentication information is information stored in a storage (not illustrated) and capable of identifying at least one of the mobile device 11 and the user 20. The response signal RS is an example of an authentication signal.

The control device 13 includes a reception interface 133. The reception interface 133 is configured as an interface for accepting various signals received by the communication device 12 through short-range wireless communication.

The processor 132 of the control device 13 is configured to match the authentication information included in the response signal RS received by the communication device 12 with the authentication information of the mobile device 11 stored in advance in a storage (not illustrated). When the matching degree between the two information items exceeds a threshold value, the processor 132 determines that the authentication processing is succeeded.

As illustrated in FIG. 1, the authentication system 10 includes a magnetic source 14. The magnetic source 14 is configured to form a magnetic field at least outside the vehicle cabin 31. In the present embodiment, the magnetic source 14 is a permanent magnet disposed in the door 32 of the vehicle 30. Examples of the permanent magnet include a neodymium magnet, a samarium cobalt magnet, and the like.

As illustrated in FIG. 2, the authentication system 10 includes a magnetic sensor 114 for detecting magnetism. The magnetic sensor 114 is installed in the mobile device 11.

The processor 113 of the mobile device 11 is configured to determine whether the intensity of the magnetism detected by the magnetic sensor 114 is no less than a threshold value. The threshold value is determined as a value exceeding the intensity of the terrestrial magnetism and capable of being detected in a range A′ illustrated in FIG. 1. The range A′ is narrower than the wireless communication area A. Magnetism having an intensity that is no less than a threshold value is an example of specific magnetism.

As illustrated in FIG. 2, the processor 113 is configured to transmit a magnetism detection signal MS from the transmitter 112 by radio waves in a case where it is determined that the intensity of the magnetism detected by the magnetic sensor 114 is no less than the threshold value. The magnetism detection signal MS is received by the communication device 12 through the short-range wireless communication, and is received by the reception interface 133 of the control device 13.

In a case where it is determined that the reception interface 133 receives the magnetic detection signal and the authentication processing is succeeded, the processor 132 is configured to output, from the output interface 131, an operation control signal OC for causing the locking/unlocking device 41 to perform a locking/unlocking operation. The locking/unlocking device 41 is configured to perform the locking/unlocking operation for the door 32 based on the operation control signal OC.

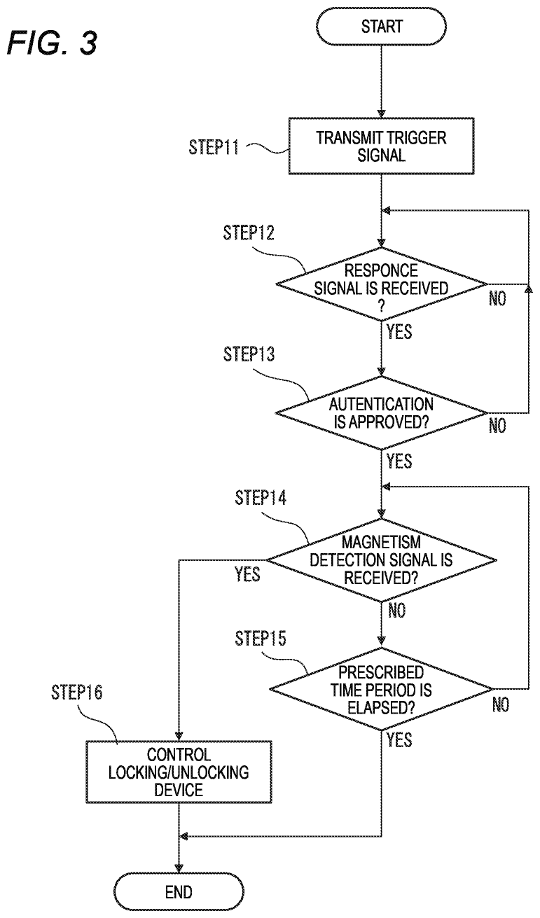

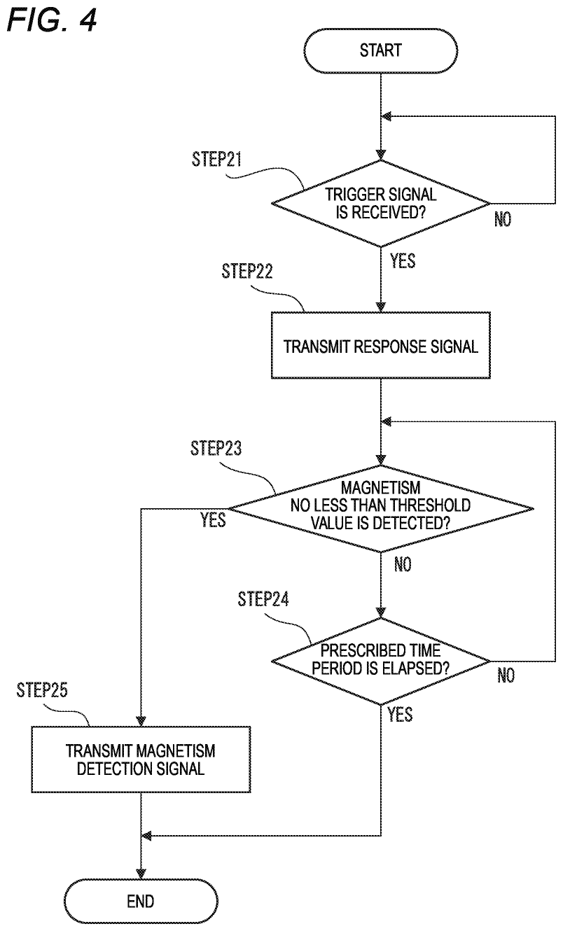

Referring to FIGS. 3 and 4, a flow of processing performed in the authentication system 10 configured as described above will be described. FIG. 3 illustrates an example of a flow of processing executed by the processor 132 of the control device 13. FIG. 4 illustrates an example of a flow of processing executed by the processor 113 of the mobile device 11.

First, the processor 132 of the control device 13 outputs the transmission control signal TC from the output interface 131, and starts transmitting the trigger signal TR by radio waves from the communication device 12 (STEP11).

Subsequently, the processor 132 of the control device 13 determines whether the response signal RS is received from the mobile device 11 by the communication device 12 (STEP12). The processing is continued until it is determined that the response signal RS is received (NO in STEP12).

On the other hand, the processor 113 of the mobile device 11 determines whether the trigger signal TR is received by the receiver 111 (STEP21 in FIG. 4). The processing is continued until it is determined that the trigger signal TR is received (NO in STEP21).

In a case where it is determined that the trigger signal TR is received (YES in STEP21), the processor 113 of the mobile device 11 transmits the response signal RS from the transmitter 112 by radio waves (STEP22).

Next, in STEP23, the processor 113 of the mobile device 11 determines whether the magnetic sensor 114 detects magnetism having an intensity that is no less than a threshold value. In a case where it is determined that the magnetism having the intensity that is no less than the threshold value is not detected (NO in STEP23), the processor 113 determines whether a prescribed time period has elapsed since the transmission of the response signal RS (STEP24). In a case where it is determined that the prescribed time period has not elapsed (NO in STEP24), the processing returns to STEP23. In a case where it is determined that the prescribed time period has elapsed (YES in STEP24), the processing is terminated without permitting the operation control of the locking/unlocking device 41. Alternatively, the processing may be returned to STEP21 to retry the authentication processing.

In a case where it is determined that the magnetic sensor 114 detects magnetism having an intensity that is no less than the threshold value (YES in STEP23), the processor 113 transmits the magnetism detection signal MS from the transmitter 112 by radio waves (STEP25).

In a case where it is determined that the response signal RS is received by the communication device 12 (YES in STEP12 in FIG. 3), the processor 132 of the control device 13 collates the authentication information included in the response signal RS with the authentication information stored in advance in the storage (not illustrated), and determines whether the authentication processing is succeeded (STEP13). In a case where it is determined that the authentication processing is not succeeded due to a mismatch in the authentication information or the like (NO in STEP13), the processing is returned to STEP12, and the reception of the response signal RS is awaited again.

In a case where it is determined that the authentication processing is succeeded (YES in STEP13), the processor 132 of the control device 13 determines whether the magnetism detection signal MS transmitted from the mobile device 11 is received by the reception interface 133 (STEP14). In a case where it is determined that the magnetism detection signal MS is not received (NO in STEP14), the processor 113 determines whether a prescribed time period has elapsed since the reception of the response signal RS (STEP15). In a case where it is determined that the prescribed time period has not elapsed (NO in STEP15), the processing is returned to STEP14. In a case where it is determined that the prescribed time period has elapsed (YES in STEP15), the processing is terminated without permitting the operation control of the locking/unlocking device 41. Alternatively, the processing may be returned to STEP12 and restarted from the authentication processing.

In a case where it is determined that the magnetism detection signal MS is received by the reception interface 133 (YES in STEP14), the processor 132 outputs the operation control signal OC from the output interface 131 to control the operation of the locking/unlocking device 41 (STEP16).

According to the configuration described above, when the mobile device 11 carried by the user 20 enters the wireless communication area A formed at least outside the vehicle cabin 31, the authentication processing is initiated, and when the magnetic source 14 detects magnetism having an intensity that is no less than the threshold value caused by the magnetic field formed at least outside the vehicle cabin 31, the operation control of the locking/unlocking device 41 is permitted. That is, the user 20 does not need to perform an operation input with respect to the mobile device 11 in order to cause the control device 13 to perform the operation control of the locking/unlocking device 41, nor does the user 20 need to perform a touch operation with respect to a door handle or the like. Since the user 20 can operate the locking/unlocking device 41 with a minimum amount of operation outside the vehicle cabin 31, and there is no need to provide a facility such as a touch sensor on the door 32 of the vehicle 30, it is possible to enhance the convenience of the authentication system 10 using the mobile device 11 that can be carried by the user 20.

Further, by setting the range in which the magnetism having such an intensity is detected to, for example, approximately several tens of centimeters (the communication distance assumed by the proximity wireless communication) from the communication device 12, the locking/unlocking device 41 can be operated by an operation of holding the mobile device 11 over the position where the communication device 12 is disposed. That is, it is possible to provide the user 20 with a feeling of operation like the proximity wireless communication without additionally providing a facility for realizing the proximity wireless communication.

As described above, in the present embodiment, the permanent magnet is used as the magnetic source 14. The location of the permanent magnet and the direction of the magnetic field to be formed are appropriately determined according to the position where the mobile device 11 shall be located at the time when the operation control of the locking/unlocking device 41 is permitted.

In this case, since it is unnecessary to supply current from the outside in order to form a magnetic field, it is possible to provide a configuration capable of suppressing increase in costs and sizes.

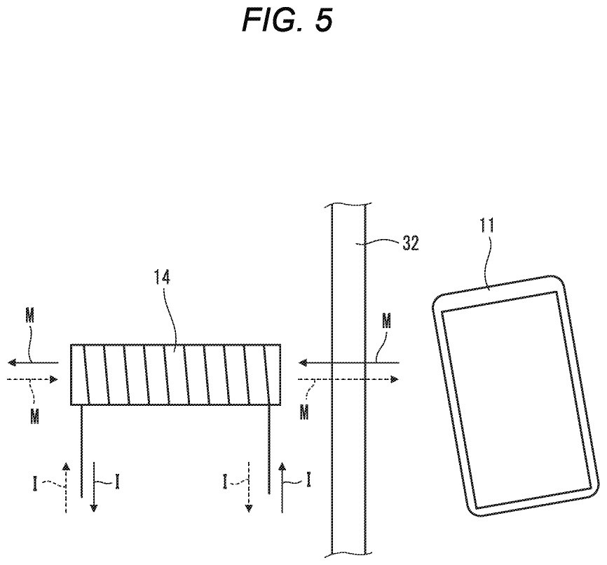

However, as illustrated in FIG. 5, an electromagnet may be used as the magnetic source 14. The location of the electromagnet and the direction of the magnetic field to be formed are appropriately determined according to the position where the mobile device 11 shall be located at the time when the operation control of the locking/unlocking device 41 is permitted.

In this case, as illustrated in FIG. 2, the processor 132 of the control device 13 may be configured to output, from the output interface 131, a current control signal CC for cyclically changing the direction of the current supplied to the electromagnet. As illustrated in FIG. 5, when the direction of the current I supplied to the electromagnet is cyclically changed, the directions of the magnetic poles of the electromagnet cyclically change. Accordingly, in addition to or instead of the fact that the intensity of the magnetism to be detected is no less than the threshold value, a fact that magnetism M in which the directions of the magnetic poles cyclically change is detected by the magnetic sensor 114 may be a condition for transmitting the magnetism detection signal MS. The magnetism in which the directions of the magnetic poles cyclically change is an example of the specific magnetism.

As illustrated in FIG. 2, the processor 113 of the mobile device 11 may be configured to transmit a satisfaction signal SS from the transmitter 112 by radio waves. Specifically, the processor 113 may be configured to be capable of acquiring the received radio wave intensity of the trigger signal TR at the receiver 111. The processor 113 is configured to output a satisfaction signal SS from the transmitter 112 when the intensity of the trigger signal TR received by the receiver 111 is no less than a threshold value and the intensity of the magnetism detected by the magnetic sensor 114 is no less than the threshold value. The threshold value of the radio wave intensity may be determined as a value of the radio wave intensity that can be acquired in the range A′ illustrated in FIG. 1.

The satisfaction signal SS is received by the communication device 12 through the short-range wireless communication, and is received by the reception interface 133 of the control device 13.

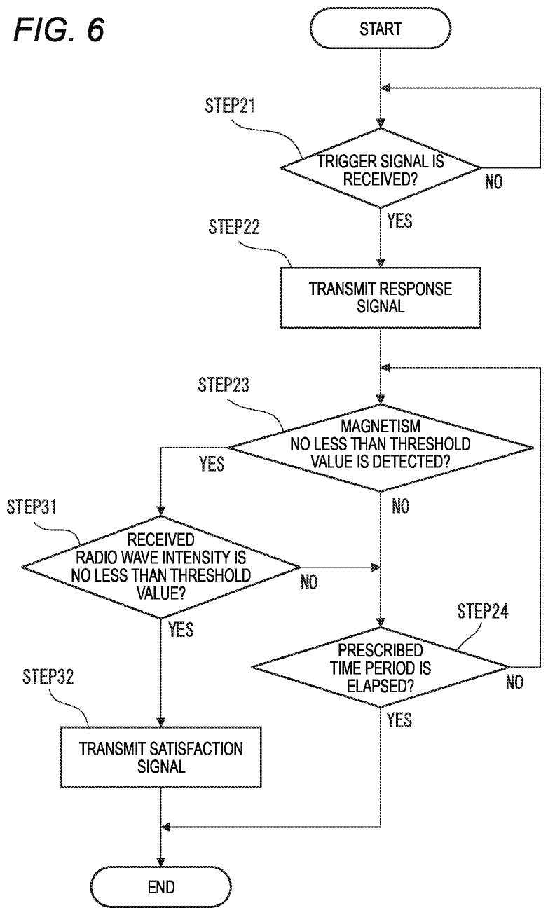

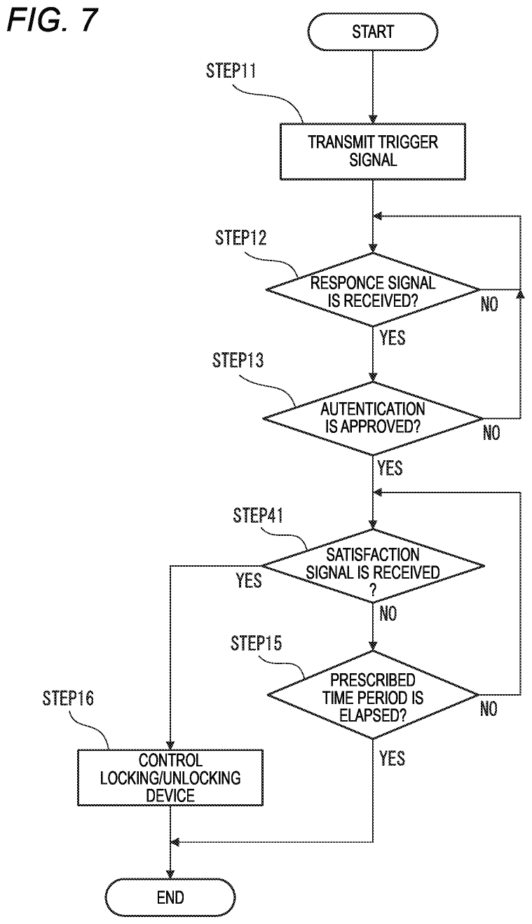

FIG. 6 illustrates a flow of processing executed by the processor 113 of the mobile device 11 in this example. Processing elements substantially the same as those in the example illustrated in FIG. 4 are assigned with the same reference numerals, and repetitive descriptions for those will be omitted. FIG. 7 illustrates a flow of processing executed by the processor 132 of the control device 13 in this example. Processing elements substantially the same as those in the example illustrated in FIG. 3 are assigned with the same reference numerals, and repetitive descriptions for those will be omitted.

In this example, in a case where it is determined that the magnetism having the intensity that is no less than the threshold value is detected by the magnetic sensor 114 (YES in STEP23 in FIG. 6), the processor 113 of the mobile device 11 determines whether the radio wave intensity of the trigger signal TR received by the receiver 111 is no less than the threshold value (STEP31). In a case where it is determined that the radio wave intensity of the trigger signal TR received by the receiver 111 is less than the threshold value (NO in STEP31), the processing proceeds to STEP24.

In a case where it is determined that the radio wave intensity of the trigger signal TR received by the receiver 111 is no less than the threshold value (YES in STEP31), the processor 113 transmits the satisfaction signal SS from the transmitter 112 by radio waves (STEP32).

On the other hand, the processor 132 of the control device 13 determines whether the satisfaction signal SS transmitted from the mobile device 11 is received by the reception interface 133 (STEP41). In a case where it is determined that the satisfaction signal SS is not received (NO in STEP41), the processing proceeds to STEP15.

In a case where it is determined that the satisfaction signal SS is received by the reception interface 133 (YES in STEP41), the processor 132 outputs the operation control signal OC from the output interface 131 to control the operation of the locking/unlocking device 41 (STEP16).

By adding a fact that the trigger signal TR having a radio wave intensity that is no less than a threshold value is detected by the receiver 111 of the mobile device 11 as a condition for permitting the operation control of the locking/unlocking device 41, it is possible to reduce the possibility that the operation control of the locking/unlocking device 41 happens to be permitted unexpectedly, so that the security of the authentication system 10 can be enhanced. In addition, it is possible to enhance affinity with a configuration in which the fact that the trigger signal TR having a radio wave intensity that is no less than the threshold value is received by the receiver 111 is the condition for transmitting the response signal RS (the condition for initiating the authentication processing).

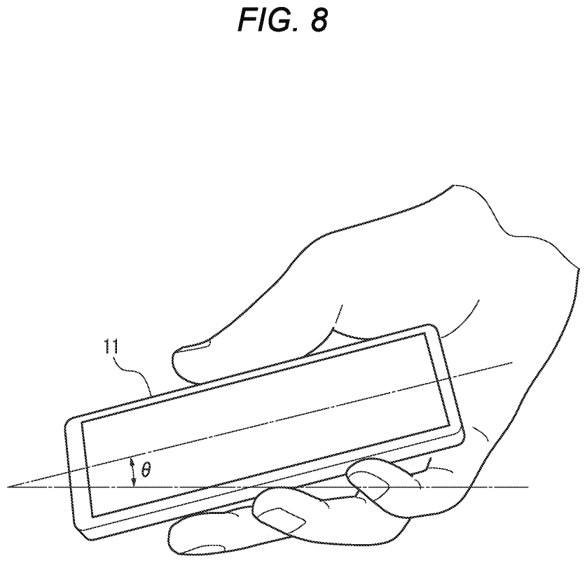

As illustrated in FIG. 2, the authentication system 10 may include a tilt sensor 115. The tilt sensor 115 is installed in the mobile device 11. As illustrated in FIG. 8, the tilt sensor 115 is configured to detect the tilt θ of the mobile device 11. The tit θ is defined as an inclination of a straight line extending in the longitudinal direction of the mobile device 11 relative to a straight line extending in a prescribed direction. Examples of the prescribed direction include a horizontal direction, a vertical direction, a direction defined for a specific component in the vehicle 30 (a longitudinal direction of the door handle, a direction in which a lower frame of a window extends), and the like. The tilt sensor 115 can be realized by a well-known acceleration sensor or the like.

In this example, the processor 113 of the mobile device 11 is configured to output the satisfaction signal SS from the transmitter 112 when the intensity of the trigger signal TR received by the receiver 111 is no less than the threshold value and the tit θ of the mobile device 11 with respect to the prescribed direction detected by the tilt sensor 115 is no greater than a threshold value. The threshold value as for the tit θ is determined based on an operation in which the user 20 intentionally matches the longitudinal direction of the mobile device 11 with respect to the prescribed direction determined as described above. In other words, it is determined as a value at which the condition is not satisfied unless the user 20 intentionally performs the operation.

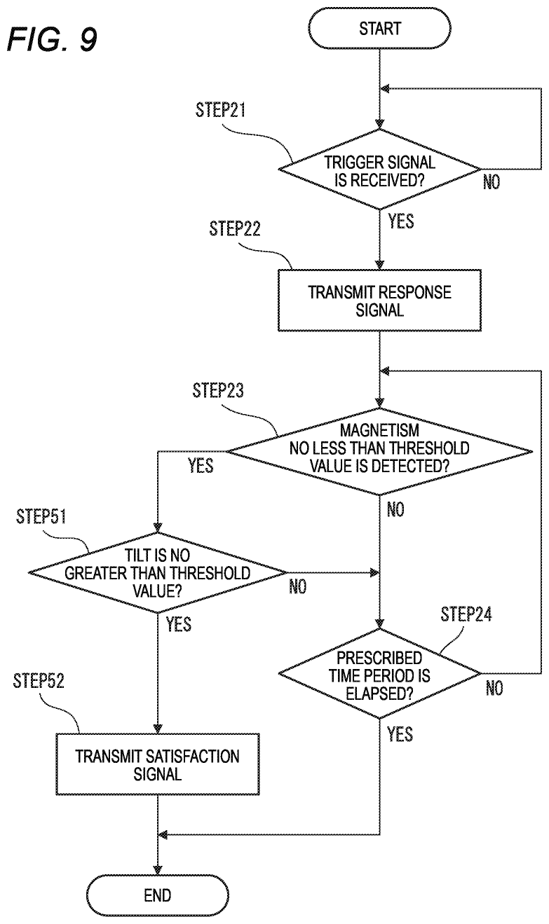

FIG. 9 illustrates a flow of processing executed by the processor 113 of the mobile device 11 in this example. Processing elements substantially the same as those in the example illustrated in FIG. 4 are assigned with the same reference numerals, and repetitive descriptions for those will be omitted.

In this example, in a case where it is determined that the magnetism having the intensity that is no less than the threshold value is detected by the magnetic sensor 114 (YES in STEP23), the processor 113 of the mobile device 11 determines whether the tit θ of the mobile device 11 detected by the tilt sensor 115 is no greater than the threshold value (STEP51). In a case where it is determined that the tit θ of the mobile device 11 is greater than the threshold value (NO in STEP51), the processing proceeds to STEP24.

In a case where it is determined that the tit θ of the mobile device 11 is no greater than the threshold value (YES in STEP51), the processor 113 transmits the satisfaction signal SS from the transmitter 112 by radio waves (STEP52).

Since the flow of the processing performed on the satisfaction signal SS by the processor 132 of the control device 13 is as described with reference to FIG. 7, repetitive descriptions for those will be omitted.

By adding a fact that the mobile device 11 takes a specific attitude detected by the tilt sensor 115 as a condition for permitting the operation control of the locking/unlocking device 41, it is possible to reduce the possibility that the operation control of the locking/unlocking device 41 happens to be permitted unexpectedly, so that the security of the authentication system 10 can be enhanced.

The processing described with reference to FIG. 6 and the processing described with reference to FIG. 9 may be combined. That is, both the fact that the receiver 111 of the mobile device 11 receives the trigger signal TR having a radio wave intensity that is no less than the threshold value and the fact that the mobile device 11 takes a specific attitude can be added to the condition for permitting the operation control of the locking/unlocking device 41. As a result, it is possible to further enhance the security of the authentication system 10.

In the present embodiment, each of the determination as to whether the intensity of the magnetism detected by the magnetic sensor 114 is no less than the threshold value, the determination as to whether the intensity of the trigger signal TR received by the receiver 111 is no less than the threshold value, and the determination as to whether the tilt of the mobile device 11 detected by the tilt sensor 115 is no greater than the threshold value is performed by the processor 113 of the mobile device 11. However, the mobile device 11 may be configured such that at least one of the intensity value of the magnetism detected by the magnetic sensor 114, the intensity value of the trigger signal TR received by the receiver 111, and the tilt value of the mobile device 11 detected by the tilt sensor 115 is transmitted from the transmitter 112 by radio waves. In this case, based on the value received by the communication device 12, the processor 132 of the control device 13 determines whether the condition for permitting the operation control of the locking/unlocking device 41 is satisfied.

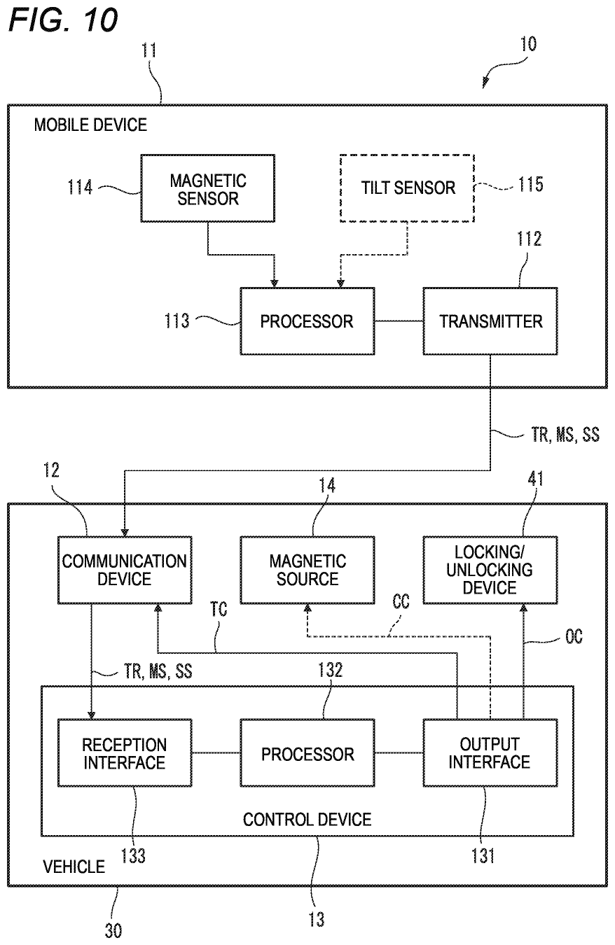

FIG. 10 illustrates a functional configuration of an authentication system 10 according to a second embodiment. Components substantially the same as those in the first embodiment are assigned with the same reference numerals, and repetitive descriptions for those will be omitted. In the present embodiment, a trigger signal TR for initiating the authentication processing is transmitted from the mobile device 11 side by radio waves. The trigger signal TR may include authentication information that is required for the authentication of the mobile device 11. The trigger signal TR according to the present embodiment is an example of the authentication signal.

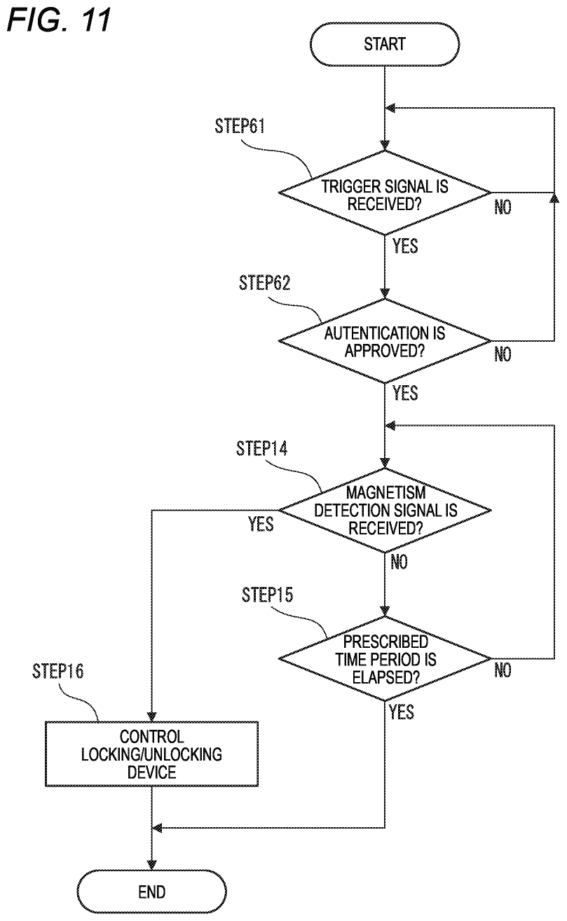

FIG. 11 illustrates an example of a flow of processing executed by the processor 132 of the control device 13 according to the present embodiment. Processing elements substantially the same as those in the example illustrated in FIG. 3 are assigned with the same reference numerals, and repetitive descriptions for those will be omitted.

First, the processor 113 of the mobile device 11 starts transmitting the trigger signal TR by radio waves from the transmitter 112.

The processor 132 of the control device 13 determines whether the trigger signal TR is received by the communication device 12 (STEP61). The processing is continued until it is determined that the trigger signal TR is received (NO in STEP61).

In a case where it is determined that the trigger signal TR is received by the communication device 12 (YES in STEP61), the processor 132 of the control device 13 collates the authentication information included in the trigger signal TR with the authentication information stored in advance in a storage (not illustrated), and determines whether the authentication processing is succeeded (STEP62). In a case where it is determined that the authentication processing is not succeeded due to a mismatch in the authentication information or the like (NO in STEP62), the processing is returned to STEP61, and the reception of the trigger signal TR is awaited again.

In a case where it is determined that the authentication processing is succeeded (YES in STEP62), the subsequent processing is the same as the processing illustrated in FIG. 3.

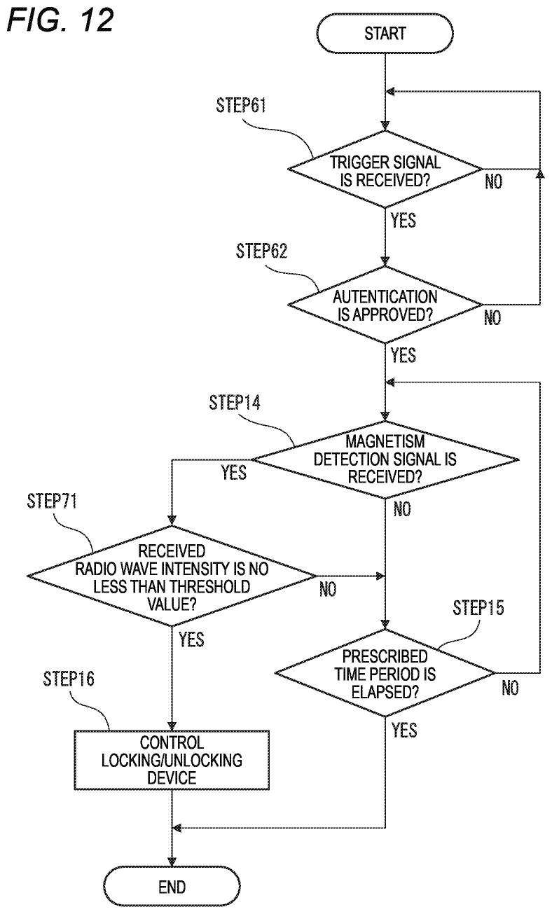

FIG. 12 illustrates another example of the flow of processing executed by the processor 132 of the control device 13 according to the present embodiment. In this example, the processor 132 is configured to acquire the radio wave intensity of the trigger signal TR received by the communication device 12. Processing elements substantially the same as those in the example illustrated in FIG. 11 are assigned with the same reference numerals, and repetitive descriptions for those will be omitted.

In this example, in a case where it is determined that the magnetism detection signal MS is received by the reception interface 133 (YES in STEP14), the processor 132 determines whether the radio wave intensity of the trigger signal TR received by the communication device 12 is no less than the threshold value (STEP71). In a case where it is determined that the radio wave intensity of the trigger signal TR is less than the threshold value (NO in STEP71), the processing proceeds to STEP15.

In a case where it is determined that the radio wave intensity of the trigger signal TR received by the communication device 12 is no less than the threshold value (YES in STEP71), the processor 132 outputs, from the output interface 131, the operation control signal OC to control the operation of the locking/unlocking device 41 (STEP16).

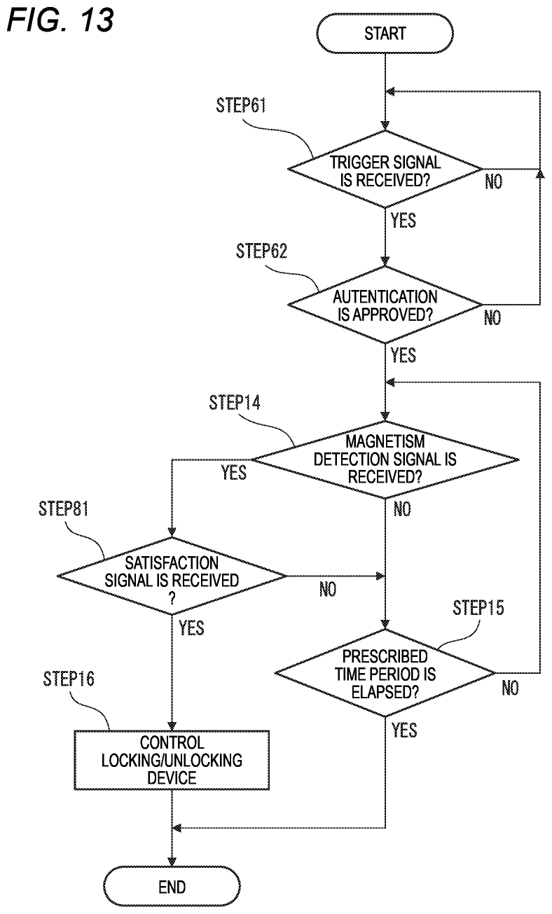

FIG. 13 illustrates another example of the flow of processing executed by the processor 132 of the control device 13 according to the present embodiment. The present example is applied to a configuration wherein the satisfaction signal SS is transmitted from the mobile device 11 by radio waves in a case where the intensity of the magnetism detected by the magnetic sensor 114 is no less than a threshold value and the tit θ of the mobile device 11 detected by the tilt sensor 115 is no greater than a threshold value. Processing elements substantially the same as those in the example illustrated in FIG. 11 are assigned with the same reference numerals, and repetitive descriptions for those will be omitted.

In this example, in a case where it is determined that the magnetism detection signal MS is received by the reception interface 133 (YES in STEP14), the processor 132 determines whether the satisfaction signal SS is received by the reception interface 133 (STEP81). In a case where it is determined that the satisfaction signal SS is not received (NO in STEP81), the processing proceeds to STEP15.

In a case where it is determined that the satisfaction signal SS is received by the reception interface 133 (YES in STEP81), the processor 132 outputs, from the output interface 131, the operation control signal OC to control the operation of the locking/unlocking device 41 (STEP16).

The processing described with reference to FIG. 12 and the processing described with reference to FIG. 13 can be combined. That is, both the fact that the communication device 12 receives the trigger signal TR having a radio wave intensity that is no less than the threshold value and the fact that the mobile device 11 takes a specific attitude can be added to the condition for permitting the operation control of the locking/unlocking device 41.

In the present embodiment, each of the determination as to whether the intensity of the magnetism detected by the magnetic sensor 114 is no less than the threshold value and the determination as to whether the inclination of the mobile device 11 detected by the tilt sensor 115 is no greater than the threshold value is performed by the processor 113 of the mobile device 11. However, the mobile device 11 may be configured such that at least one of the intensity value of the magnetism detected by the magnetic sensor 114 and the tilt value of the mobile device 11 detected by the tilt sensor 115 is transmitted from the transmitter 112 by radio waves. In this case, based on the value received by the communication device 12, the processor 132 of the control device 13 determines whether the condition for permitting the operation control of the locking/unlocking device 41 is satisfied.

The processor 132 of the control device 13 having each function described above can be realized by a general-purpose microprocessor operating in cooperation with a general-purpose memory. Examples of the general-purpose microprocessor include a CPU, an MPU, and a GPU. Examples of the general-purpose memory include a ROM and a RAM. In this case, a computer program for executing the above-described processing can be stored in the ROM. ROM is an example of a non-transitory computer-readable medium having recorded a computer program. The general-purpose microprocessor designates at least a part of a computer program stored in the ROM, loads the program on the RAM, and executes the processing described above in cooperation with the RAM. The above-described computer program may be pre-installed in the general-purpose memory, or may be downloaded from an external server device 60 via a wireless communication network 50 illustrated in FIG. 1 and then installed in the general-purpose memory. In this case, the external server device 60 is an example of the non-transitory computer-readable medium storing the computer program.

The processor 132 may be implemented by a dedicated integrated circuit capable of executing the above-described computer program, such as a microcontroller, an ASIC, and an FPGA. In this case, the above-described computer program is pre-installed in the storage element included in the dedicated integrated circuit. The memory element is an example of the non-transitory computer-readable medium storing a computer program. Each processor may also be implemented by a combination of the general-purpose microprocessor and the dedicated integrated circuit.

The processor 113 of the mobile device 11 having each function described above can be realized by a general-purpose microprocessor operating in cooperation with a general-purpose memory. Examples of the general-purpose microprocessor include a CPU, an MPU, and a GPU. Examples of the general-purpose memory include a ROM and a RAM. In this case, a computer program for executing the above-described processing can be stored in the ROM. ROM is an example of a non-transitory computer-readable medium having recorded a computer program. The general-purpose microprocessor designates at least a part of a computer program stored in the ROM, loads the program on the RAM, and executes the processing described above in cooperation with the RAM. The above-described computer program may be pre-installed in the general-purpose memory, or may be downloaded from an external server device 60 via a wireless communication network 50 illustrated in FIG. 1 and then installed in the general-purpose memory. In this case, the external server device 60 is an example of the non-transitory computer-readable medium storing the computer program.

The processor 113 may be implemented by a dedicated integrated circuit capable of executing the above-described computer program, such as a microcontroller, an ASIC, and an FPGA. In this case, the above-described computer program is pre-installed in the storage element included in the dedicated integrated circuit. The memory element is an example of the non-transitory computer-readable medium storing a computer program. Each processor may also be implemented by a combination of the general-purpose microprocessor and the dedicated integrated circuit.

Each of the above embodiments is merely illustrative for facilitating understanding of the presently disclosed subject matter. The configuration according to each of the above embodiments can be appropriately modified or changed without departing from the gist of the presently disclosed subject matter.

In each of the above embodiments, after it is determined that the authentication processing for authenticating the mobile device 11 is succeeded, it is determined at least whether the intensity of the magnetism detected by the magnetic sensor 114 is no less than the threshold value. However, it may be determined whether the authentication processing for authenticating the mobile device 11 is succeeded after it is determined at least whether the intensity of the magnetism detected by the magnetic sensor 114 is no less than the threshold value.

In each of the above embodiments, the control device 13 is installed in the vehicle 30. According to such a configuration, it is easy to suppress a communication delay that may occur in short-range wireless communication with the mobile device 11.

However, at least a part of the authentication processing performed by the processor 132 of the control device 13 may be performed in the mobile device 11 or the external server device 60.

The authentication system 10 may be installed in a mobile entity other than the vehicle 30. Examples of other mobile entities include railways, aircraft, and ships. Such mobile entities may not require a driver.

The opening/closing body to be locked/unlocked by the locking/unlocking device is not limited to the door of the vehicle 30. Doors and windows in houses and facilities may also be an example of the opening/closing body.

The controlled device controlled by the control device 13 is not limited to the locking/unlocking device. An activation device for activating a driving source of the vehicle 30, a security device, a lighting device, an air conditioner, and an audio-visual device in the vehicle 30 or the above-described house or facility may also be examples of the controlled device.

The present application is based on Japanese Patent Application No. 2020-205874 filed on Dec. 11, 2020, the entire contents of which are incorporated herein by reference.

What is claimed is:

1. An authentication system, comprising:
a communication device configured to form a wireless communication area at least outside of a cabin arranged to be opened/closed by an opening/closing body;
a magnetic source configured to form a magnetic field at least outside of the cabin;
a mobile device adapted to be carried by a user;
a magnetic sensor installed in the mobile device and configured to detect magnetism; and
a control device configured to determine whether an authentication processing for authenticating the mobile device located in the wireless communication area with radio waves is succeeded, and configured to control an operation of a controlled device in a case where a specific magnetism is detected by the magnetic sensor and it is determined that the authentication processing is succeeded.

2. The authentication system according to claim 1,
wherein the authentication system is configured to acquire an intensity of the radio waves received by either the communication device or the mobile device; and
wherein the control device is configured to control the operation of the controlled device in a case where: the intensity of the radio waves acquired is no less than a threshold value; the specific magnetism is detected by the magnetic sensor; and it is determined that the authentication processing is succeeded.

3. The authentication system according to claim 1, further comprising:
a tilt sensor installed in the mobile device and configured to detect a tilt of the mobile device relative to a prescribed direction,
wherein the control device is configured to control the operation of the controlled device in a case where: the tilt detected by the tilt sensor is no greater than a threshold value; the specific magnetism is detected by the magnetic sensor; and it is determined that the authentication processing is succeeded.

4. The authentication system according to claim 1, further comprising:
a tilt sensor installed in the mobile device and configured to detect a tilt of the mobile device relative to a prescribed direction,
wherein the authentication system is configured to acquire an intensity of the radio waves received by either the communication device or the mobile device; and
wherein the control device is configured to control the operation of the controlled device in a case where: the tilt detected by the tilt sensor is no greater than a threshold value; the intensity of the radio waves acquired is no less than a threshold value; the specific magnetism is detected by the magnetic sensor; and it is determined that the authentication processing is succeeded.

5. The authentication system according to claim 1,
wherein the magnetic source is a permanent magnet;
wherein the specific magnetism is magnetism having an intensity that is no less than a threshold value.

6. The authentication system according to claim 1,
wherein the magnetic source is an electromagnet in which directions of magnetic poles are variable;
wherein the specific magnetism is magnetism in which directions of magnetic poles cyclically change.

7. The authentication system according to claim 1,
wherein the controlled device is installed in a mobile entity.

8. The authentication system according to claim 7,
wherein the control device is installed in the mobile entity.

9. The authentication system according to claim 1,
wherein the controlled device includes a locking/unlocking device configured to lock/unlock the opening/closing body.

10. A control device configured to control an operation of a controlled device, comprising:
a processor configured to cause a communication device to form a wireless communication area at least outside of a cabin arranged to be opened/closed by an opening/closing body, and configured to determine whether an authentication processing for authenticating a mobile device adapted to be carried by a user located in the wireless communication area with radio waves is succeeded; and
a reception interface configured to receive, from the mobile device with the radio waves, a magnetism detection signal indicating that the mobile device detects a specific magnetism,
wherein the processor is configured to control the operation of the controlled device in a case where the reception interface receives the magnetism detection signal and it is determined that the authentication processing is succeeded.

11. A mobile device adapted to be carried by a user, comprising:
a transmitter configured to transmit an authentication signal including information required by an authentication processing for authenticating the mobile device to a communication device configured to form a wireless communication area at least outside of a cabin arranged to be opened/closed by an opening/closing body;
a magnetic sensor installed in the mobile device and configured to detect magnetism of a magnetic field formed at least outside of the cabin;
a processor configured to transmit a magnetism detection signal from the transmitter to the communication device in a case where the magnetic sensor detects a specific magnetism.

12. A non-transitory computer-readable medium having recorded a computer program adapted to be executed by a processor installed in a control device configured to control an operation of a controlled device, and configured to, when executed, cause the control device to:
cause a communication device to form a wireless communication area at least outside of a cabin arranged to be opened/closed by an opening/closing body;
determine whether an authentication processing for authenticating a mobile device adapted to be carried by a user located in the wireless communication area with radio waves is succeeded;
determine whether a magnetism detection signal indicating that the mobile device detects a specific magnetism is received from the mobile device with the radio waves; and
control the operation of the controlled device in a case where the reception interface receives the magnetism detection signal and it is determined that the authentication processing is succeeded.

13. A non-transitory computer-readable medium having recorded a computer program adapted to be executed by a processor installed in a mobile device adapted to be carried by a user, and configured to, when executed, cause the mobile device to:
transmit an authentication signal including information required by an authentication processing for authenticating the mobile device to a communication device configured to form a wireless communication area at least outside of a cabin arranged to be opened/closed by an opening/closing body;
cause a magnetic sensor to detect magnetism formed at least outside of the cabin;
determine whether a specific magnetism is detected by the magnetic sensor; and
transmit a magnetism detection signal to the communication device in a case where it is determined that the specific magnetism is detected.
